(19) United States
(12) Patent Application Publication
(10) Pub. No.: US 2006/0043226 A1
(43) Pub. Date: Mar. 2, 2006

(54) Apparatus and method for grinding with staggered cutters

(76) Inventors: Keith Roozeboom, Pella, IA (US); Jerry Roorda, Leighton, IA (US)

Correspondence Address: MERCHANT & GOULD PC, P.O. BOX 2903, MINNEAPOLIS, MN, 55402-0903, US

(21) Appl. No.: 11/210,459

(22) Filed: Aug. 23, 2005

Related U.S. Application Data
(60) Provisional application No. 60/604,287, filed on Aug. 24, 2004.

(51) Int. Cl. B02C 13/28

(52) U.S. Cl. 241/294

(57) ABSTRACT

A grinding apparatus including a drum and a plurality of cutters mounted on through-members that extend through the drum. The cutters have a primary cutting edge and two secondary cutting edges located on either side of the primary cutting edge. During operation, impact from the cutters act only upon a planar impact surface of an anvil located in relation to the drum.

### CROSS-REFERENCE TO RELATED APPLICATIONS

This application claims the benefit of Provisional Application No. 60/604,287, filed Aug. 24, 2004, which application is incorporated herein by reference.

### TECHNICAL FIELD

The principles disclosed relate to a rotary drum used for grinding or shredding materials. More particularly, this disclosure relates to an arrangement and a configuration of cutter(s) that mount to a rotary drum for grinding materials, and associated methods.

### BACKGROUND

Waste material such as trees, brush, stumps, pallets, railroad ties, peat moss, paper, wet organic materials and the like are often processed with machines that generally fall into one of two categories: grinders or shredders. Grinders typically function by forcing material into contact with a rotating cylindrical drum having cutters located at an outer diameter of the drum. The cutters travel at a relatively high rate of speed; typically exceeding 5000 feet per minute. Shredders also typically function by forcing material into contact with a rotating cylindrical drum having cutters located at an outer diameter of the drum. The shredder cutters, however, travel at a relatively low rate of speed; typically less than 500 feet per minute. Both types of machines include a shear bar or anvil, and typically a screen that retains pieces of un-ground or un-shredded material.

One type of grinder is known as a tub grinder. Examples of tub grinders are described in U.S. Pat. Nos. 5,507,441 and 5,419,502. Another type of grinder is known as a horizontal grinder. Examples of horizontal grinders are described in U.S. Pat. Nos. 5,975,443; 5,947,395; 6,227,469; and 6,299,082. Examples of shredders are described in U.S. Pat. Nos. 4,927,088; 5,971,305; and 6,394,376.

The construction of a rotary drum and the drum's position relative to an anvil or a screen is important to the performance of a machine. In particular, the position of the drum relative to the anvil often affects the ability of a machine to process a variety of sizes and types of material. The feeding mechanism of a machine also affects the performance; for instance, tub grinders that feed material from the top of a rotary drum and allow the material to be fed by gravity perform differently than horizontal grinders that feed material by a table conveyor to a rotary drum. In addition, the arrangement and the configuration of cutter(s) on the drum affects the performance of a machine.

FIG. 1 illustrates a drum assembly 5, configured as disclosed in commonly assigned U.S. Pat. No. 6,422,495, which is incorporated herein by reference. The drum assembly has an axis of rotation 7 and includes through-members 10 supported and guided in a drum skin 20 by sleeves 30. Each of the sleeves 30 is secured to the drum skin 20. Referring now to FIG. 2, a cutter 40 is attached to the through-member 10. The through-member 10 is held in position by the interaction of the cutter 40 with a shoulder 32 of the sleeve 30. A second cutter 41 (FIG. 1) located on an opposite end of the through-member 10 likewise holds the through-member 10 in position by the interaction of the second cutter 41 with the sleeve 30.

Referring now to FIG. 3, the through-member 10 is oriented at an angle A relative to the axis of rotation 7. In FIG. 3, the through-member 10 is shown in two positions. In the first position, represented by solid lines, cutting edges 46, 47 of the first and second cutters 40, 41 can been seen. In the second position, represented by dashed lines, the through-member 10 is positioned as though the drum has rotated 180 degrees from the first position. In the second position, the cutting edges 46, 47 of the cutters 40, 41 have swept across a longitudinal cutting path. The longitudinal cutting path is represented by reference numbers 42 and 43. The cutters 40, 41 overlap one another along the longitudinal cutting path as the cutters 40, 41 rotate from the first position to the second position so that the longitudinal cutting path is a continuous cutting path.

Each of the cutters of the drum assembly 5 is positioned such that the longitudinal cutting paths of all cutters are adjacent, or slightly overlapped. Thereby, the longitudinal cutting paths form a continuous cutting cylinder, to ensure the drum assembly 5 has full-face cutting coverage. Full-face cutting coverage ensures that a cutter will impact any material presented to the grinding drum.

FIG. 4 illustrates a side view of the drum assembly 5. The drum assembly 5 has an anvil 8 and a screen 9. During operation, a continuous cutting cylinder 44, defined by full-face cutting coverage as previously described, forms a contoured surface 54 in a large log 50 as the log is being ground lengthwise. FIG. 5 further illustrates a top view of a log 50, backed away a short distance from a drum, to better illustrate the contoured surface 54. With the cutters 40, 41 as depicted in FIG. 1, grinding action occurs as the cutter impacts the end grain of the log 50. As shown in FIG. 4, once the shape of the void in the log matches the cutting cylinder (i.e., once the contoured surface 54 is formed) multiple cutters are in-contact with the contoured surface 54 of the log, forcing the log to stay at a position in which log engagement of the following cutters is limited. Smaller logs interact with each other and tend to move randomly about, reorienting themselves against the drum. With larger logs, this random movement typically does not occur.

The contoured surface 54 of the log 50 is a relatively smooth arcuate surface corresponding to the continuous cutting cylinder 44. During the grinding operation, a feed mechanism will interact with the log to attempt to move the log forward into the grinding assembly 5. Conventional feed mechanisms often have some discontinuity permitting the log to move longitudinally, at least slightly. What is meant by longitudinally is that the log may slightly move in a direction parallel to the longitudinal axis of rotation 7 of the drum, as represented by arrows B in FIG. 5. Because of the formation of the contoured surface 54 in relation to the continuous cutting cylinder 44, these random longitudinal movements of the log do not significantly affect the orientation of the contoured surface 54 relative to the drum to aid in re-orienting the log 50. Rather, the log tends to remain in place by contact between the continuous cutting cylinder 44 and the contoured surface 54, resulting in somewhat “stalled” grinding operation. Cutting productivity of the grinder is thus hindered.

In general, a need exists for an improved cutter to address the unique requirements of grinding logs of large diameter with a horizontal grinder.

### SUMMARY

In one aspect, the present disclosure relates to a grinding apparatus for grinding material. The grinding apparatus includes a drum defining two different cutting diameters and a planar anvil having a planar impact surface. During operation of the grinding apparatus, impact from the drum on the material acts only upon the planar impact surface.

In another aspect, the present disclosure relates to a grinding apparatus including a drum. The drum defines a first cutting diameter and a second cutting diameter, the second cutting diameter being less than the first cutting diameter. The apparatus further includes a plurality of cutters secured to the drum. Each of the cutters includes a primary cutting edge and two secondary cutting edges located on either side of the primary cutting edge. The primary cutting edge defines the first cutting diameter of the drum, and the secondary cutting edge defining the second cutting diameter of the drum.

In yet another aspect, the present disclosure relates to a cutter for use on a grinding drum. The cutter includes a body having three cutting edges: including first and second lateral cutting edges located on either side of a center cutting edge. The body also includes mounting structure for mounting the cutter to a grinding drum.

In still another aspect, the present disclosure relates to a method of grinding. The method includes the steps of providing a drum having a plurality of cutters, feeding material to the drum in a first direction, and forming a grooved cutting pattern in the material. Grooves of the grooved cutting pattern are formed by three staggered cutting edges formed on each of the cutters.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a perspective view of a cutter drum of the prior art, typically as used with a tub grinder, including cutters mounted with two bolts;

FIG. 2 is a partial cross-sectional view of a cutter drum, similar to the cutter drum of FIG. 1, typically as used with a horizontal grinder, including cutters mounted with one bolt;

FIG. 3 is a front elevation view of a through-member of the cutter drum of FIG. 1, shown in first and second positions.

FIG. 4 is a partial side view of a horizontal grinder with the prior art cutter drum of FIG. 1, and a large diameter log;

FIG. 5 is a partial top view of through members of a cutter drum in a horizontal grinder with prior art cutters, previously used with tub grinders, mounted with two bolts, and illustrated with a large diameter log;

FIG. 6 is a partial side view of a horizontal grinder having a drum assembly in accord with the principles of the present disclosure;

FIG. 7 is a partial top view of the horizontal grinder of FIG. 6;

FIG. 8 is front perspective view of one embodiment of a cutter of the drum assembly of FIG. 6, in accord with the principles of the present disclosure;

FIG. 9 is a side view of the cutter of FIG. 8;

FIG. 10 is a front perspective view of another embodiment of a cutter for use with the drum assembly of FIG. 6, in accord with the principles of the present disclosure;

FIG. 11 is a side view of the cutter of FIG. 10;

FIG. 12 is a front perspective view of yet another embodiment of a cutter for use with the drum assembly of FIG. 6, in accord with the principles of the present disclosure;

FIG. 13 is a side view of the cutter of FIG. 12;

FIG. 14 is a side view of still another embodiment of a cutter, shown in exploded assembly with the drum assembly of FIG. 6; and

FIG. 15 is a side view of another embodiment of a cutter in accord with the principles of the present disclosure.

### DETAILED DESCRIPTION

With reference now to the various figures in which identical elements are numbered identically throughout, a description of various exemplary aspects of the present invention will now be provided. The preferred embodiments are shown in the drawings and described with the understanding that the present disclosure is to be considered an exemplification of the invention and is not intended to limit the invention to the embodiments disclosed.

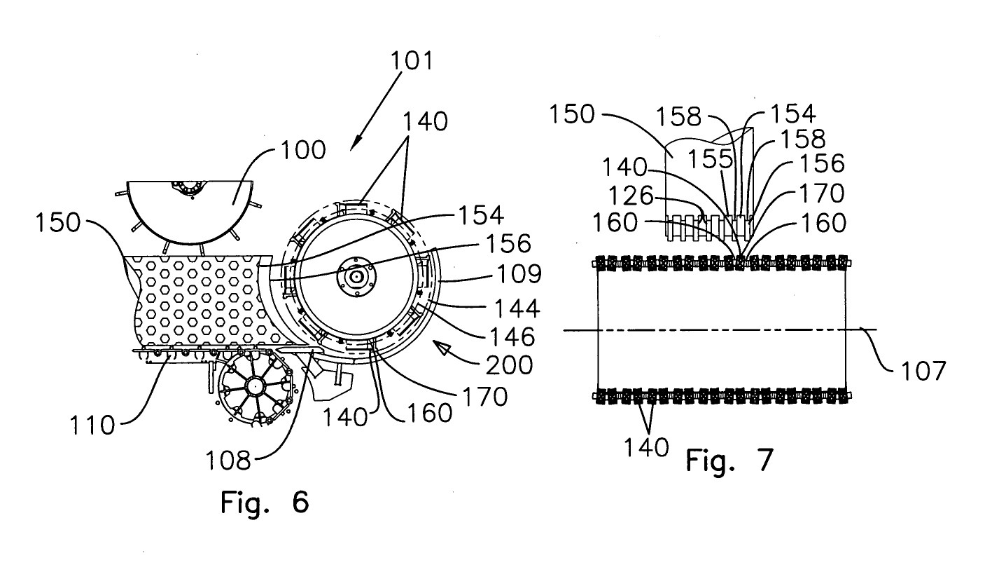

FIG. 6 illustrates one arrangement of a horizontal grinder 101 in accord with the present disclosure. The horizontal grinder 101 includes an upper feed roller 100, a lower conveyor 110, and a grinding drum or drum assembly 200 having a longitudinal axis 107 (FIG. 7) that defines an axis of rotation. The grinder 101 also includes a screen 109, and an anvil 108. A similar arrangement of a horizontal grinder is described in commonly assigned U.S. application Ser. No. 10/783,339, which is incorporated herein by reference.

The anvil 108 of the horizontal grinder 101 is a planar anvil having a planar impact surface 118. During operation of the grinder 101, impact from the drum 200 on material acts against only the planar impact surface 118. In contrast, some conventional arrangements include shredder feet, such as the feet constructions described in U.S. Pat. No. 6,227,469, which receive impact from a drum. The anvil 108 of the present disclosure is planar and does not include the added feet constructions; thereby reducing costs associated with additional assembly and manufacture of feet, as well as added maintenance costs associated with repair and replacement of broken or damaged shedder feet.

Still referring to FIG. 6, a relatively large log 150, partially ground by the grinding drum 200, is illustrated. The log 150 has primary and secondary contoured surfaces 154, 156 formed by contact with the grinding drum 200. The log 150 is shown in a position slightly retracted from contact with the grinding drum 200 to better show the contoured surfaces 154, 156.

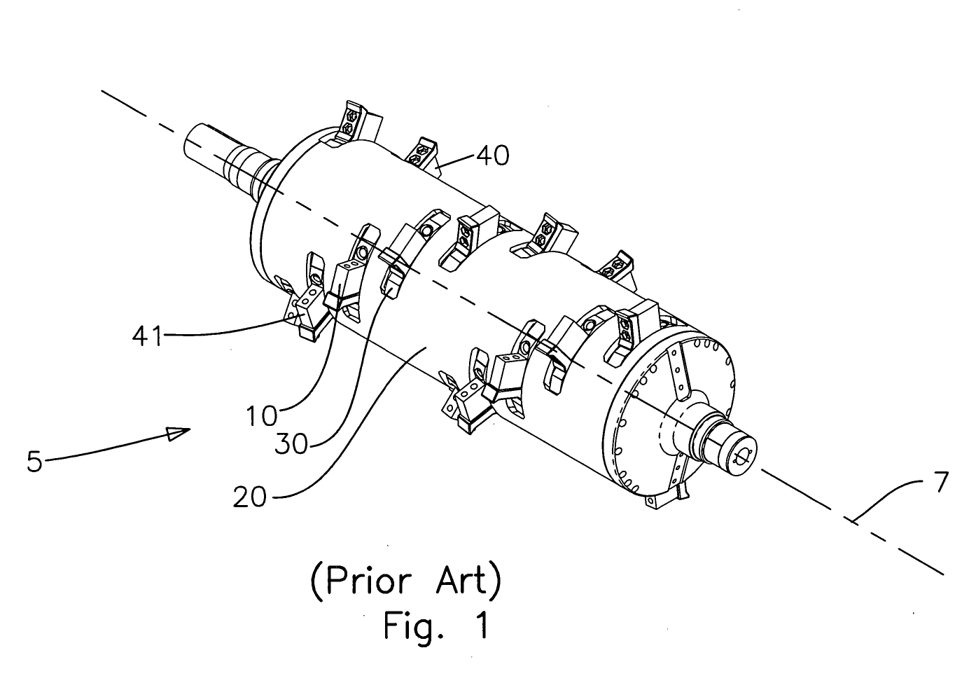

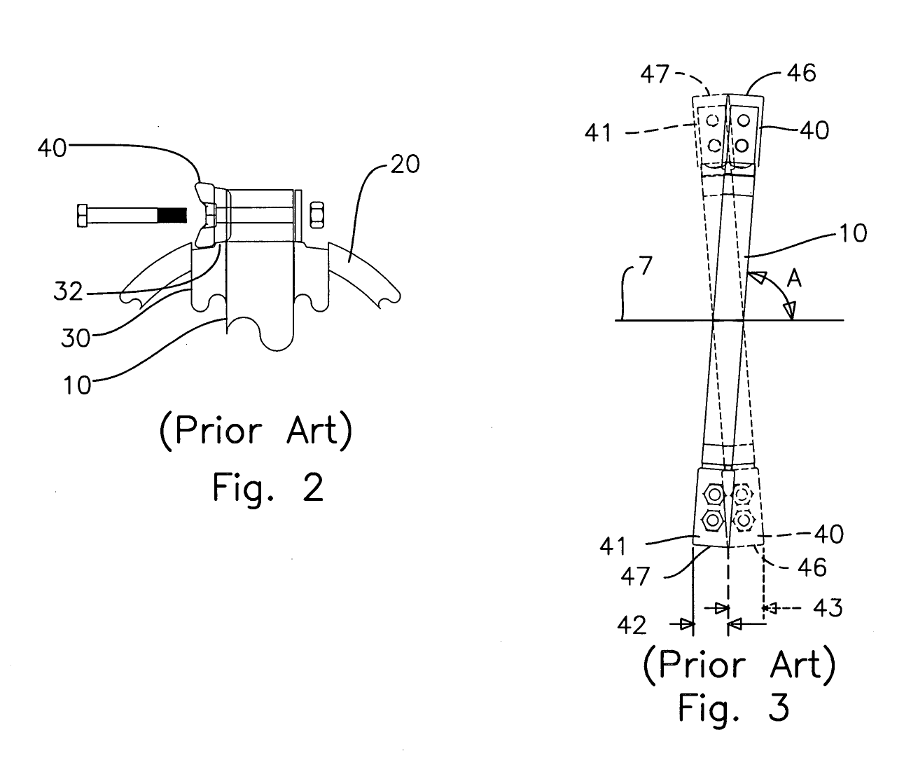

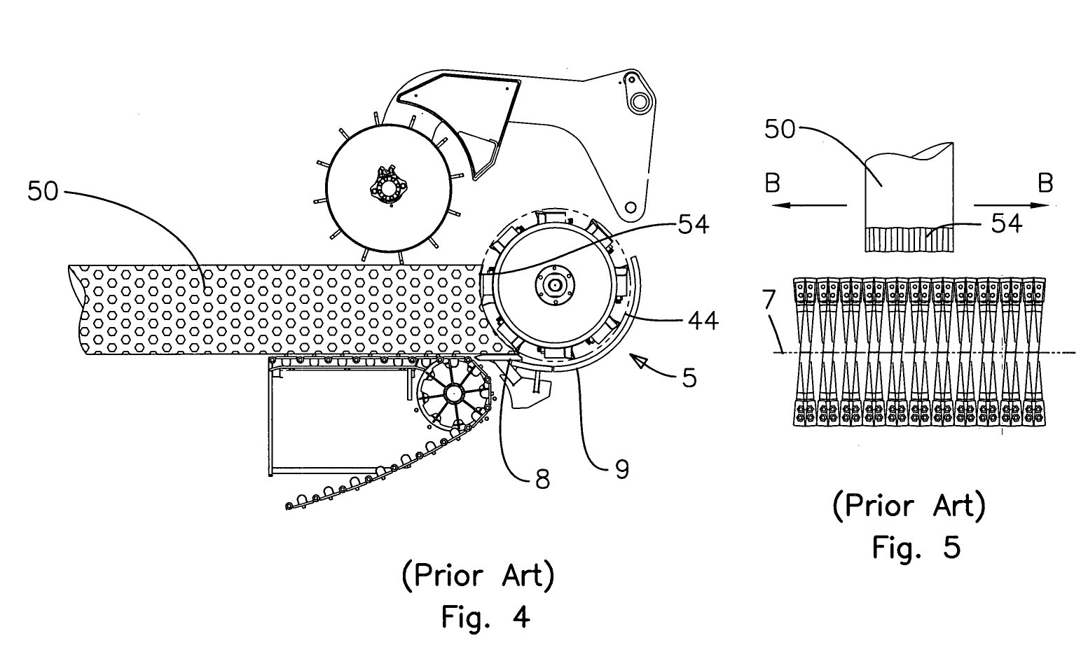

The grinding drum 200 includes a plurality of cutters 140 staggered along the longitudinal axis 107 of the drum 200 (similar to the drum assembly 5 illustrated in FIG. 1). Each of the cutters 140 passes through a longitudinal cutting path during rotation, as previously described in the description of the prior art and shown in FIG. 3. Each of the cutters 140 of the present disclosure, however, provides two different cutting diameters: a first cutting diameter 144 that forms the primary contoured surface 154 in ground material, and a second cutting diameter 146 that forms the secondary contoured surface 156 in ground material. The first cutting diameter 144 is greater than the second cutting diameter 146.

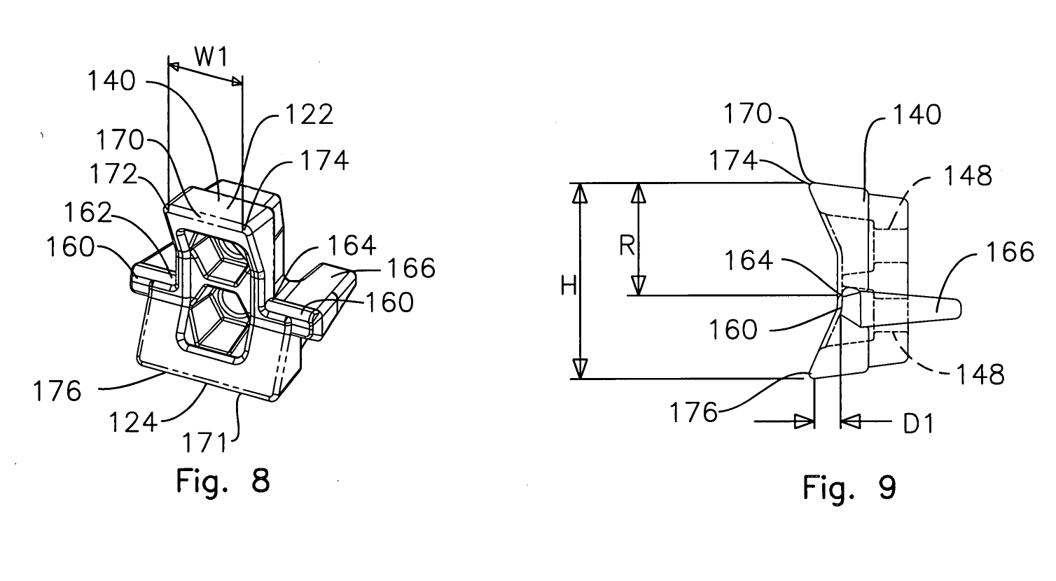

Referring now to FIGS. 8 and 9, one embodiment of the cutter 140 in accord with the principles disclosed is illustrated in isolation from the grinding drum 200. The cutter 140 includes a primary cutting edge 170 that defines the first cutting diameter 144 of the drum 200, and secondary cutting edges 160 that defines the second cutting diameter 146 of the drum. In the illustrated embodiment, the primary cutting edge 170 is centrally located on the cutter 140. The secondary cutting edges 160 are laterally located, that is, located on either side of the centrally located primary cutting edge 170.

The primary cutting edge 170 is configured to provide a robust cutting structure, while also acting to aggressively cut materials. Such structure can include a blunt edge coated with a hardening material to resist wear. One known hard material is commonly referred to as hard facing. Hard facing includes particles of carbide held in a bead of weld material that can be disposed along the cutting edge or structure. Other types of cutting structures and hardening materials can be used in accord with the principles disclosed.

Still referring to FIG. 8, the primary cutting edge 170 has a width W1. The width W1 of the primary cutting edge 170 is defined between opposite corners 172, 174 of the cutting edge 170. The width W1 affects the cutting characteristics and durability of the cutter 140. In particular, as the width is decreased, the cutter becomes more aggressive, but less robust. For example, taken to an extreme, if the primary cutting edge 170 was reduced to ¼ inches or less, the primary cutting edge 170 would essentially be a sharp point. However, the edge would be fragile and experience excessive and rapid wear. In the preferred embodiment, the width W1 of the primary cutting edge 170 is at least 0.625 inches, and can vary to accommodate a specific application, or accommodate a particular size of drum or a set number of cutters. The width W1 of the primary cutting edge 170 of the cutter 140 illustrated in FIG. 8 is approximately 1.5 inches.

The secondary cutting edges 160 of the cutter 140 can be uniquely constructed, as the secondary cutting edges 160 are subjected to significantly different loads than the load experienced by the primary cutting edge 170. The secondary cutting edges 160 can thereby be configured to provide different cutting characteristics than the primary cutting edge 170. FIGS. 8 and 9 illustrate one arrangement wherein the secondary cutting edges 160 are relatively blunt and set back a distance D1 (FIG. 9) from the primary cutting edge 170.

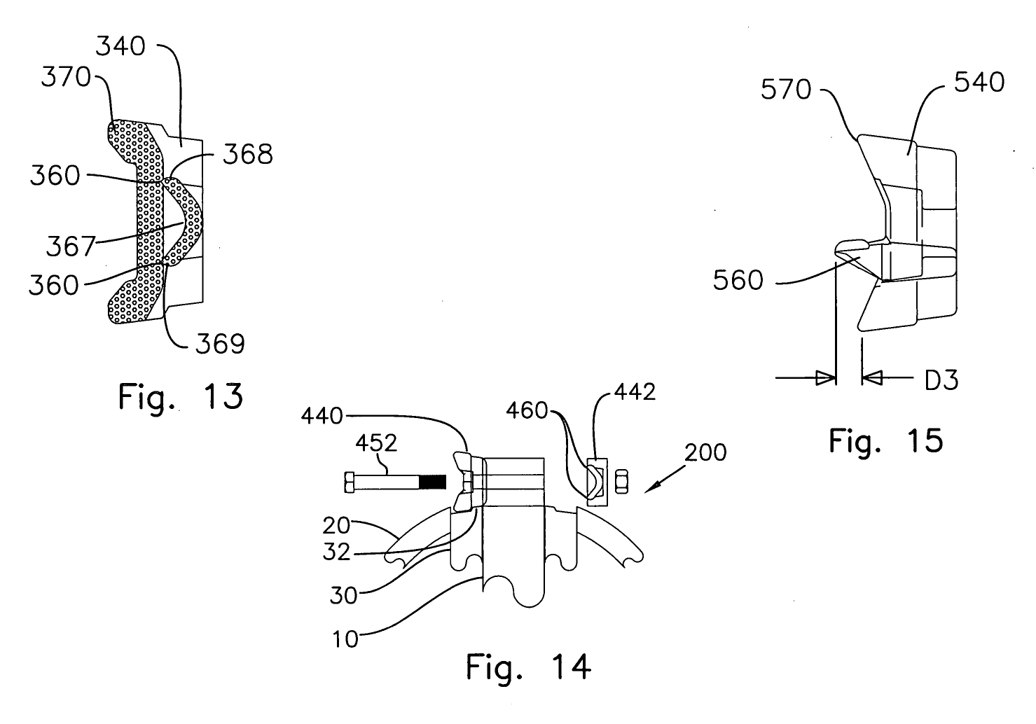

In assembly, the cutter 140 mounts to the through-member 10 (see FIG. 14, for example) of the drum 200. In the embodiment shown in FIGS. 8 and 9, two bolts (not shown) are used to mount the cutter 140 in relation to the drum 200. The bolts are inserted through holes 148 (FIG. 9) formed in the cutter 140 to secure the cutter 140 to the through-member 10. The cutter 140 further includes ear structures 166 located opposite the secondary cutting edges 160. The ear structures 166 extend rearward from the cutter 140 and contact the through-member 10 when assembled to provide additional structural support to the cutting edges 160.

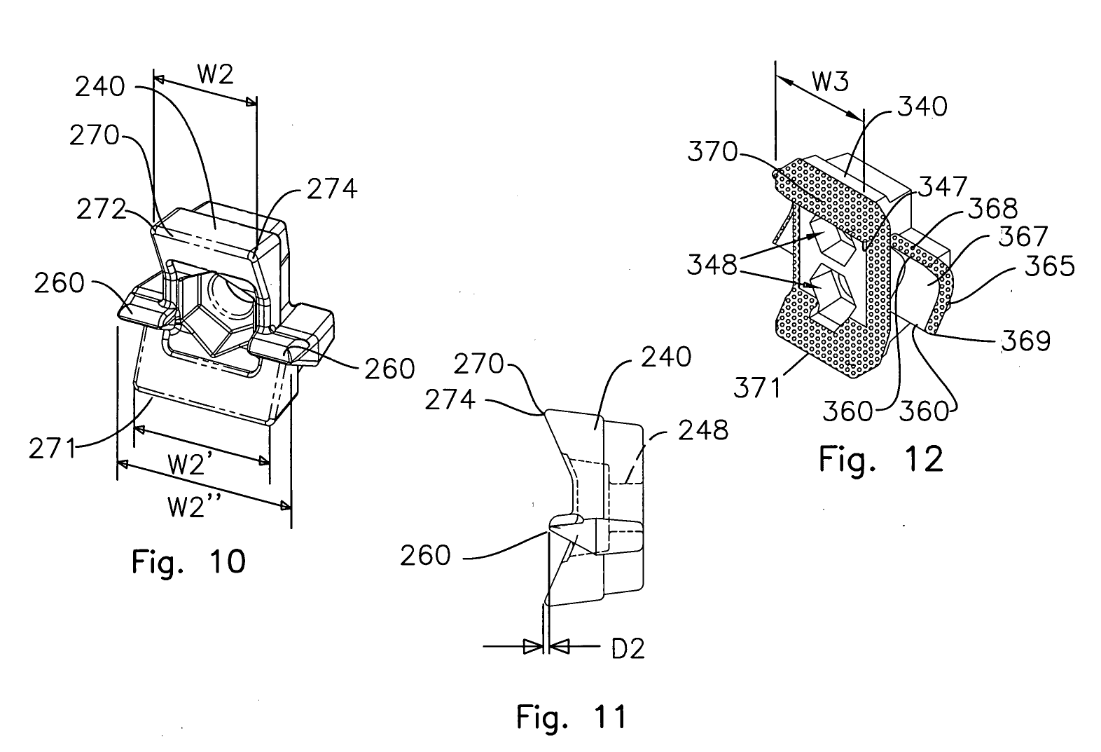

Referring now to FIGS. 10 and 11, another embodiment of a cutter 240 in accord with the principles disclosed is illustrated. The cutter 240 includes a primary cutting edge 270 that defines the first cutting diameter 144 of the drum 200, and secondary cutting edges 260 that defines the second cutting diameter 146 of the drum. The primary cutting edge 270 is centrally located on the cutter 240. The secondary cutting edges 260 are laterally located, that is, located on either side of the centrally located primary cutting edge 270.

Referring to FIG. 10, the primary cutting edge 270 of the cutter 240 has a width W2. The width W2 of the primary cutting edge 270 is defined between opposite corners 272, 274 of the cutting edge 270. In the preferred embodiment, the width W2 of the primary cutting edge 270 is at least 0.625 inches; the width W2 of the primary cutting edge 270 of the cutter 240 illustrated in FIG. 10 is approximately 2.0 inches.

Also, as previously discussed, the secondary cutting edges 260 of the cutter 240 illustrated in FIGS. 10 and 11 can be uniquely constructed. Referring to FIG. 11, another arrangement is illustrated wherein the secondary cutting edges 260 are relatively sharper than that of the first embodiment. The sharper secondary cutting edges 260 are located more in alignment with primary cutting edge 270, as represented by a set back distance of D2. In this embodiment, the set back distance D2 is different than the embodiment illustrated in FIG. 9. It is contemplated that the secondary cutting edges can extend forward even further. For example, the secondary cutting edges can extend forward to align with the primary cutting edge, or extend forward to a leading position as shown in FIG. 15. In FIG. 15, another cutter 540 illustrates secondary cutting edges 560 that are offset from the primary cutting edge 570 a distance D3; the distance D3 is forward of the primary cutting edge 570. The embodiments of FIGS. 9, 11 and 15 are examples of possible configurations. The fore-aft relationship of the primary and secondary cutting edges can be varied to meet manufacturing or design requirements.

In assembly, the cutter 240 mounts to the through-member 10 of the drum 200. In the embodiment shown in FIGS. 10 and 11, one bolt (as shown, for example, in FIG. 14 at reference number 452) is used to mount the cutter 240 in relation to the drum 200. The bolt is inserted through a hole 248 formed in the cutter 240 to secure the cutter 240 to the through-member 10.

Referring now to FIGS. 12 and 13, yet another embodiment of a cutter 340 in accord with the principles disclosed is illustrated. The cutter 340 includes a primary cutting edge 370 that defines the first cutting diameter 144 of the drum 200, and secondary cutting edges 360 that defines the second cutting diameter 146 of the drum. The primary cutting edge 370 is centrally located on the cutter 340. The secondary cutting edges 360 are laterally located, that is, located on either side of the centrally located primary cutting edge 370.

Referring to FIG. 12, the primary cutting edge 370 has a width W3. The width W3 of the primary cutting edge 370 is defined between opposite corners 372, 374 of the cutting edge 370. In the preferred embodiment, the width W3 of the primary cutting edge 370 is at least 0.625 inches; the width W3 of the primary cutting edge 370 of the cutter 340 illustrated in FIG. 12 is approximately 2.0 inches.

Also, as previously discussed, the secondary cutting edges 360 of the cutter 340 illustrated in FIG. 13 can be uniquely constructed. FIG. 13 illustrates another arrangement wherein the secondary cutting edges 360 include a pair of secondary cutting edges (i.e., upper and lower cutting edges) on each side of the primary cutting edge 370. In particular, the secondary cutting edges 360 are defined by projections 365 that form a concave front face 367. Tapering ends 368, 369 of the projections 365 intersect at each of the upper and lower secondary cutting edges 360.

In each of the previous embodiments, the cutters 140, 240, and 340 are reversible cutters. In particular, the primary cutting edge (e.g. 170 of FIG. 8) is located on a first end 122 of the cutter and a second primary cutting edge 171 (and 271, 371 of FIGS. 10 and 12) is located on an opposite end 124 of the cutter 140. In the embodiments of FIGS. 8 and 10, the secondary cutting edges 160, 260 may or may not provide a secondary cutting diameter when mounted in the reversed orientation, depending upon the width of the second primary cutting edge 171, 271. That is, if the second primary cutting edge (e.g. 271) has a width (e.g. W2′ shown in FIG. 10) that is less than an outer width W2″ defined by the two secondary cutting edges 260, the cutter 240 will then provide the first and second cutting diameters 144, 146 as previously described. If the width W2′ of the second primary cutting edge 271 is equal to or greater than the outer width W2″, then the cutter will provide a cutting path similar to that provided by the prior art (i.e., a smooth and continuous contoured surface 54).

Referring back to FIGS. 12 and 13, in the cutter embodiment 340, the two primary cutting edges 370, 371 are generally symmetric and the pair of secondary cutting edges 360 provides the same cutting characteristics regardless of mounting orientation (i.e. reversed or non-reversed). This feature can also be incorporated into the embodiments of FIGS. 8 and 10, as the secondary cutting edges 160, 260 maybe generally centrally located so that the edges 160, 260 can be utilized in either mounting orientation. With regards to the embodiment of FIG. 12, the pair of upper and lower secondary cutting edges 360 provides a useful feature wherein one (e.g., the lower) of the secondary cutting edges 360 of the pair will remain substantially sharp as the other (e.g., the upper) secondary cutting edge 360 of the pair wears. The cutter 340 can then be reversed to utilize an unworn second primary cutting edge 371 and the opposite unworn secondary cutting edges 360.

In assembly, the cutter 340 mounts to the through-member 10 of the drum 200. In the embodiment shown in FIGS. 12 and 13, two bolts (not shown) are used to mount the cutter 340 in relation to the drum 200. The bolts are inserted through holes 348 formed in the cutter 340 to secure the cutter 340 to the through-member 10.

Referring now to FIG. 14, still another embodiment of a cutter 440 in accord with the principles of the present disclosure is illustrated. This cutter is similar to the embodiment illustrated in FIGS. 12 and 13 with the exception that secondary cutting edges 460 are provided by a separate component than the component that defines the primary cutting edge 470. In particular, in this embodiment, the secondary cutting edges 460 are formed on a cutter piece 442 that mounts to a backside of the cutter 440. As can be understood, other secondary cutting edge embodiments, such as those shown in FIGS. 8-11, can also be provided by a separate component as described with regards to FIG. 14.

One common feature of each of the cutter embodiments 140, 240, 340, 440 is that the secondary cutting edges, e.g. 160, are offset from the primary cutting edge, e.g. 170, a radial distance R defined between points 172 and 162 or points 174 and 164 as labeled in FIG. 9. The radial distance between the primary cutting edge 170 and the secondary cutting edges 160 defines a staggered profile of cutting edges 160, 170.

The radial distance R can range from a minimum distance of one-half inch to a maximum distance defined by a substantial portion of an overall height H of the cutter 140 (between point 172 and 176). In the first cutter embodiment illustrated in FIG. 9, the overall height H of the cutter 140 is approximately 3.50 inches, and the radial distance R is approximately 2.0 inches. The radial distance R defines the depth of grooves or notches 155 cut in the log 150; or otherwise stated, will determine the length of ears 158 formed in the end of the log. As can be understood, the notches 155 correspond to the primary contoured surface 154 and the ears 158 correspond to the secondary contoured surface 156 of the log 150.

The various embodiments illustrated provide possible variations of primary and secondary cutting edge configurations and are not intended to be limiting. The features of the described cutters can be alternatively arranged in accord with the principles disclosed to provide a number of cutter variations.

The following operational disclosure is described with regards to the first embodiment of the cutter 140, but is intended to apply to each of the cutter embodiments previously disclosed. During use, the primary cutting edge 170 of the cutters 140 cuts the notches 155 in the end of the log 150 to define the primary contoured surface 154; while the secondary cutting edges 160 cut the ears 158 in the end of the log 150 to define the secondary contoured surface 156. The notches 155 and the ears 158 define a grooved pattern formed by the staggered profile of the three cutting edges (i.e., the primary cutting edge 170 and the two lateral cutting edges 260) of each of the cutters 140.

The staggered arrangement or profile of the primary cutting edge 170 and the secondary cutting edges 160 has been found to improve the productivity of a grinding machine. In particular, the arrangement allows the width W1 of the primary cutting edge 170 of each cutter 140 to be reduced, while maintaining full face coverage across the face of the log 150. In particular, any area of the log 150 that is not contacted by a primary cutting edge 170, is contacted by a secondary cutting edge 160 to provide full face cutting coverage. Because the primary cutting edge 170 of the cutter can be reduced, any area of the log 150 contacted by the narrower primary cutting edge 170 of the cutter 140 is subjected to higher forces/pressures resulting from the reduced total width or surface of primary cutting edge 170.

In addition, forming notches 155 and ears 158 in the end of the log 150 creates two corners 126 (FIG. 7) in the log 150 at the primary contoured surface 154. It is believed that the corners 126 potentially cause fracture lines that encourage the wood to be fractured or broken apart more easily. Further, because of the creation of fracture lines, the cutter 140 may include a secondary cutting edge 160 that does not need to be as robust as the primary cutting edge 170.

Also, with the discontinuity or grooved pattern formed in the face of the log (i.e., the primary and secondary contoured surfaces 154, 156, or the notches 155 and the ears 158) any random longitudinal movement of the log will result in an effective reorientation of the contoured surfaces relative to the cutting edges 170, 160. This reorientation will, for instance, align the ears 158 with the primary cutting edges 170 of the cutters 140 to reduce the occurrence of “stalled” grinding operation.

The above specification provides a complete description of the present invention. Since many embodiments of the invention can be made without departing from the spirit and scope of the invention, certain aspects of the invention reside in the claims hereinafter appended.

What is claimed is:

1. A grinding apparatus for grinding material, the grinding apparatus comprising:
a) a drum defining two different cutting diameters;
b) a plurality of cutters, each of the cutters including at least two cutting edges constructed to cut the two different cutting diameters; and
c) a planar anvil having a planar impact surface;
d) wherein during operation of the grinding apparatus, impact from the drum on the material acts only upon the planar impact surface.

2. The grinding apparatus of claim 1, wherein the cutters are staggered along a longitudinal axis of the drum.

3. The grinding apparatus of claim 1, wherein the at least two cutting edges of the cutters includes a primary cutting edge and a secondary cutting edge, the primary cutting edge being configured to cut one of the two different cutting diameters, the secondary cutting edge being configured to cut the other of the two different cutting diameters.

4. The grinding apparatus of claim 3, wherein each of the cutters is a reversible cutter, the reversible cutters including first and second primary cutting edges located on opposite ends of the cutter.

5. The grinding apparatus of claim 3, wherein each of the cutters includes two secondary cutting edges.

6. The grinding apparatus of claim 1, wherein each of the cutters includes first and second lateral cutting edges located on either side of a central cutting edge.

7. The grinding apparatus of claim 1, wherein the cutting edges of each of the cutters includes a primary cutting edge and secondary cutting edges located on either side of the primary cutting edge.

8. The grinding apparatus of claim 7, wherein the secondary cutting edges are set back a distance from the primary cutting edge.

9. The grinding apparatus of claim 7, wherein the primary cutting edge and the secondary cutting edges defines a staggered profile.

10. The grinding apparatus of claim 7, wherein each of the cutters is reversible and includes first and second primary cutting edges located on opposite ends of the cutter.

11. The grinding apparatus of claim 10, wherein each of the secondary cutting edges includes an upper secondary cutting edge and a lower secondary cutting edge.

12. The grinding apparatus of claim 1, wherein the drum includes a plurality of through-members having a first end and a second end, each of the first and second ends extending through the drum, and wherein a cutter of the plurality of cutters is mounted to each of the first and second ends of the through-members.

13. A grinding apparatus, comprising:
a) a drum defining a first cutting diameter and a second cutting diameter, the second cutting diameter being less than the first cutting diameter; and
b) a plurality of cutters secured to the drum, each of the cutters including a primary cutting edge and two secondary cutting edges located on either side of the primary cutting edge, the primary cutting edge defining the first cutting diameter of the drum, the secondary cutting edge defining the second cutting diameter of the drum.

14. The grinding apparatus of claim 13, wherein the plurality of cutters is staggered along a longitudinal axis of the drum.

15. The grinding apparatus of claim 13, wherein the secondary cutting edges are offset a distance from the primary cutting edge.

16. The grinding apparatus of claim 15, wherein the secondary cutting edges are positioned rearward of the primary cutting edge.

17. The grinding apparatus of claim 15, wherein the secondary cutting edges are positioned forward of the primary cutting edge.

18. The grinding apparatus of claim 13, further including a plurality of through-members having a first end and a second end, each of the first and second ends extending through the drum, and wherein a cutter of the plurality of cutters is mounted to each of the first and second ends of the through-members.

19. The grinding apparatus of claim 13, wherein each of the cutters is reversible and includes first and second primary cutting edges located on opposite ends of the cutter.

20. The grinding apparatus of claim 19, wherein each of the two secondary cutting edges includes an upper secondary cutting edge and a lower secondary cutting edge.

21. A cutter for use on a grinding drum, the cutter comprising:
a body having three cutting edges, including first and second lateral cutting edges located on either side of a center cutting edge, the body including mounting structure for mounting the cutter to a grinding drum.

22. The cutter of claim 21, wherein the second lateral cutting edges are set back a distance from the center cutting edge.

23. The cutter of claim 21, wherein the center cutting edge and the lateral cutting edges have a staggered profile.

24. The cutter of claim 21, wherein the cutter is reversible and includes first and second center cutting edges located on opposite ends of the cutter.

25. The cutter of claim 24, wherein each of the second lateral cutting edges includes upper and lower cutting edges.

26. A method of grinding, comprising the steps of:
a) providing a drum having a plurality of cutters;
b) feeding material to the drum in a first direction; and
c) forming a grooved cutting pattern in the material, wherein grooves of the grooved cutting pattern are formed by three staggered cutting edges formed on each of the cutters.

27. The method of claim 26, wherein the step of forming the grooved cutting pattern includes forming a first cut diameter and a second different cut diameter in the material.

28. The method of claim 27, wherein the first cut diameter is formed by a primary cutting edge of each of the cutters, and the second cut diameter is formed by a secondary cutting edge of each of the cutters.

29. The method of claim 26, wherein providing a drum having a plurality of cutters includes: providing a plurality of through-members, positioning the through-members so that first and second ends extend outward from the drum, and mounting a cutter of the plurality of cutters to each of the ends of the through-members.

30. The method of claim 29, wherein each of the cutters of the plurality of cutters is mounted in a mounting orientation, and further including reversing the mounting orientation of a worn cutter to provide an unworn cutting edge for continued use in grinding.
